(19) United States
(12) Patent Application Publication
(10) Pub. No.: US 2013/0120094 A1
(43) Pub. Date: May 16, 2013

(54) CURRENT TRANSFORMER

(71) Applicant: Atreus Enterprises Limited, Ballinasloe (IE)

(72) Inventor: Ydo Goinga, Borne (NL)

(73) Assignee: ATREUS ENTERPRISES LIMITED, Ballinasloe (IE)

(21) Appl. No.: 13/668,774

(22) Filed: Nov. 5, 2012

(30) Foreign Application Priority Data
Nov. 10, 2011 (IE) S2011/0487

(51) Int. Cl. H01F 27/28

(52) U.S. Cl. CPC H01F 27/28
USPC 336/174

(57) ABSTRACT

A current transformer comprises a plurality of primary conductors (L,N) passing through a ferromagnetic core (10) and a secondary winding (W1) wound on the core. The transformer further including a ferromagnetic member (T1) continuously surrounding the primary conductors between the primary conductors and the core.

This application claims priority to Irish application S2011/0487 filed Nov. 10, 2011, the disclosure of which is incorporated herein by reference in its entirety.

### TECHNICAL FIELD

This invention relates to a current transformer for use in, for example, residual current devices (RCDs).

### BACKGROUND

FIG. 1 shows a typical current transformer based RCD intended for detection of AC and pulsating DC residual currents. The operation of such RCDs is well-known so only a brief description will be given.

A single phase AC mains supply to a load LD comprises live L and neutral N conductors which pass through a toroidal ferromagnetic core 10 of a current transformer CT. The conductors L, N serve as primary windings of the current transformer CT, and a winding W1 on the core serves as a secondary winding. In relation to the primary conductors, the term “winding” is used in accordance with conventional terminology, even though these conductors pass directly through the core rather than being wound on it.

The currents I_{L} and I_{N} in the live and neutral conductors L, N flow in opposite directions through the core 10; thus under normal conditions the vector sum of the primary currents I_{L} and I_{N} is zero in the absence of a residual (earth fault) current I_{R}. However, the presence of a residual current I_{R} leads to a differential current in the primaries which induces a mains frequency current in the secondary winding W1. In the present context, when the vector sum of the currents flowing in multiple primary conductors is zero the primary currents are said to be balanced, whereas when the vector sum is non-zero the primary currents are said to be unbalanced and the non-zero vector sum is referred to as a differential current. The terms “residual” and “differential” are used interchangeably within this document.

The mains frequency current induced in the secondary winding W1 is detected by a WA050 RCD integrated circuit (IC) 20 powered from the mains supply (the connections to the mains supply are not shown). The IC 20 is an industry standard RCD IC supplied by Western Automation Research & Development Ltd, Ireland and described in U.S. Pat. No. 7,068,047, which is incorporated herein by reference. If the voltage developed across W1 is of sufficient magnitude and/or duration, the IC 20 will produce an output which will cause a mechanical actuator 30 to open ganged switch contacts SW in the live and neutral conductors L, N to disconnect the mains supply.

The circuit of FIG. 1 involves the use of a current transformer (CT) for detection of AC and pulsating DC residual currents. However, current transformers can also be used for the detection of DC residual currents. An example of such a circuit is shown in FIG. 2, which shows a circuit for use with either an AC or DC mains supply. In FIG. 2 the CT core 10 is driven continuously into and out of saturation by an oscillator circuit 40 so as to facilitate detection of DC differential currents. The principles of using an oscillator to facilitate detection of DC differential currents is explained in PCT/EP2011/066450, which is incorporated herein by reference.

The CT used in FIG. 1 is referred to as a passive CT (and the corresponding RCD a passive RCD) because it does not normally have any current flowing in the secondary winding in the absence of a residual current. The CT used in FIG. 2 is referred to as an active CT (and the corresponding RCD an active RCD) because it normally has an oscillatory current flowing in the secondary winding in the absence of a residual current. The circuit of FIG. 2 is used to detect a differential current I_{R} flowing in two or more primary conductors, and in fact I_{R} is the vector sum IΔ of all of the currents flowing in the primary conductors.

In IEC and other published RCD product standards, RCDs are classified as follows.
RCDs intended for detection of AC residual current only are referred to as AC Types.
RCDs intended for detection of AC and pulsating DC residual current are referred to as A Types.
RCDs intended for detection of AC, pulsating DC and pure DC residual current are referred to as B Types.

Referring again to FIG. 1, the two load carrying primary conductors L, N passing through the CT core 10 can carry balanced load currents of up to 100 A. Because the same current flows in each conductor but in opposite directions, the vector sum of these currents will be zero and ideally the output from the CT secondary W1 should be zero. FIG. 3 shows a representation produced by a software program called Vizimag of the magnetic fields produced by two load carrying conductors L, N positioned within the CT core 10 of a passive RCD such as that shown in FIG. 1 (to avoid over complex figures the secondary winding W1 is not shown in FIG. 3, nor in any of the subsequent figures showing the CT core 10, but in all cases W1 is assumed to be present). FIG. 3, and subsequent figures, also include a table containing data relating to the corresponding Vizimag diagram.

The conductors L, N are symmetrically located within the core 10 and carry a balanced load current of 50 A AC in this example. Each conductor induces a flux of 7 mT (milliTesla) in the left and right hand sides of the core respectively. The conductor L on the left produces flux lines travelling in an anticlockwise direction whereas the conductor N on the left produces flux lines travelling in a clockwise direction. The mean flux density induced in the core in this example is half the sum of the two fluxes. Thus because the fluxes are of equal magnitude and in opposite directions they effectively cancel each other such that the net flux is zero and no current will be induced into the CT secondary winding (not shown).

The Vizimag diagram in FIG. 3 shows that the flux from the left and right conductors L, N passes predominantly through the left and right hand sides of the core 10. For this reason the secondary winding W1 normally extends substantially 360 degrees round the core 10, or at least is wound on the core symmetrically relative to the primary conductors, in order that the two sets of flux equally influence the secondary winding. If there are more than two primary conductors, e.g. in multi-phase circuits, the secondary winding would again be wound 360 degrees round the core 10 or at least symmetrically relative to the primary conductors.

FIG. 4 shows the effect on the core of having a differential current of 10 mA flowing in one of the conductors, with no load current flowing.

In this example, there is no load current flowing in the conductors, and for the purpose of simulating a residual current condition a current of 10 mA is made to flow in the right hand conductor N. This current induces a flux into the core 10, and in this case the mean flux density induced is 11.5 mT. Thus the differential current flowing in the primary circuit induces a net or differential flux into the core which in turn will induce a current into the secondary winding on the core. If 10 mA were the required tripping threshold for the RCD, the data indicates that it would require 11.5 mT to cause automatic tripping.

It should be noted that in the case of FIG. 4, a 10 mA current caused a flux of 11.5 mT to be induced into the left and right hand sides of the core, whereas in the case of FIG. 3, a 50 A load currents caused just 7 mT of flux to be induced in the left and right hand sides of the core. This indicates that in the case of FIG. 3, the magnetic fields produced by each conductor undergo a high degree of cancellation in the air between the conductors and the core. Further cancellation occurs within the core where the induced fluxes of −7 mT and +7 mT flow in opposite directions and cancel. Thus the mediums for magnetic field cancellation are air and the core.

In practice, due to imperfect symmetry, for two conductors with balanced primary currents positioned within a CT core, there will always be a net flux induced into the core due to non-cancellation of the equal magnitude fluxes produced by the current flowing through two conductors. This effect is demonstrated in FIG. 5 and the accompanying data.

In FIG. 5, the two conductors have been located off centre so as to better demonstrate the effects of non-cancellation. It can be seen that there is more flux induced into the right hand side of the core compared to the left hand side, and the respective flux density levels are 10 mT for the right side as opposed to 5.2 mT in the left side, producing a mean flux of 2.4 mT. With no differential current flowing in the primary conductors, there is a net or standing flux density of 2.4 mT in the core due substantially to asymmetry of the conductors. This flux equates to a differential current of 2 mA which can be referred to as an equivalent IΔ, and will be proportional to the load current flowing in the two conductors. Thus if this load current is increased substantially, there will be a corresponding increase in the standing flux level.

It is evident from FIG. 5 that the magnetic fields produced by the two conductors do not cancel each other out within the core as is the case of FIG. 3, and it is further evident that the air between the conductors and the core is not a fully effective medium for cancellation of opposing fields of equal magnitude. The net magnetic field will therefore induce a flux into the CT core which will be detected by the CT secondary winding. Based on the example of FIG. 4 it can be assumed that for a given core size and material a differential current of 10 mA will produce a net flux density of approximately 12 mT, thus each mA produces about 1.2 mT of mean flux. The problem of non-cancellation of magnetic fields produced by balanced load currents can seriously undermine the performance of the RCD.

FIG. 5a shows a representation of a three phase circuit.

In FIG. 5a, four primary load conductors L1, L2, L3 and N of similar cross section pass symmetrically through a CT core 10. A balanced load current of 50 A is caused to flow in two of the conductors L3 and N. It should be noted that when the load current flows through just two of the four conductors, e.g. when supplying a single phase load from a three phase supply, the load carrying conductors will appear to be asymmetrically positioned within the CT, and the circuit will behave similarly to that of FIG. 5. The accompanying table shows that a resultant flux of 3 mT is induced into the CT when the circuit supplies 50 A to a single phase load. This standing flux equates to a standing residual current of about 2.5 mA.

In the USA, RCDs used for shock protection have a typical maximum trip level of 6 mA.

In other countries, 10 mA or 30 mA levels are used for shock protection. The standing flux caused by non-cancellation as demonstrated in the example of FIG. 5 would result in the following impact on RCDs with these trip levels.

TABLE 1

| Device | Load | Equivalent | | % reduction in |
|---|---|---|---|---|
| trip level | Current | standing IΔ | Net Trip Level | trip level |
| 6 mA | In | 2 mA | 4 mA | 33% |
| 10 mA | In | 2 mA | 8 mA | 20% |
| 30 mA | In | 2 mA | 28 mA | 6.7% |

It can be seen that for low trip level devices the effect of non-cancellation can be very significant, but is less critical at higher levels. However, IEC RCD product standards require an RCD to withstand 6 times its rated load current without tripping. This is sometimes referred to as a core balance test and is intended to ensure that the CT does not produce an output that would cause the RCD to trip during an inrush current condition. UL standards use a multiple of four times the rated load current. Load current is usually referred to as In. The larger load currents that occur during inrush or core balance testing, albeit temporary, will increase the standing flux and the effective equivalent standing IΔ as seen by the CT. This effect is represented in Table 6.

TABLE 2

| Device | Load | Equivalent | | % reduction in |
|---|---|---|---|---|
| trip level | Current | standing IΔ | Net Trip Level | trip level |
| 6 mA | 4 In | 8 mA | 0 mA | 100% |
| 10 mA | 6 In | 12 mA | 0 mA | 100% |
| 30 mA | 6 In | 12 mA | 18 mA | 40% |

In the case of the 6 mA and 10 mA RCDs, the device will automatically trip simply due to the increased load current with no differential current flowing in the primary circuit because the equivalent standing IΔ will be in excess of the rated tripping level of the device. In the case of the 30 mA RCD the standing IΔ of 12 mA will reduce the effective trip level of the RCD to about 18 mA. In practice a 30 mA RCD will have an actual trip level in the range 18-25 mA, so there is a high possibility that the 30 mA device could also trip under inrush load current conditions.

The problem of nuisance tripping due to non-cancellation within a passive CT can be reduced or mitigated to some extent by ensuring that the primary conductors are carefully located and aligned within the core, and that the secondary winding is evenly distributed around the core. Multiple winding layers in the secondary may also be helpful. However, these actions may not be sufficiently effective in all cases.

The problems of non-cancellation can be substantially greater in the case of active CTs due to the presence of continuously changing core saturating currents.

Unlike the passive CT, the active CT is used as an integral part of a dynamic system comprising the CT core, its windings, the saturating currents and the output stage as demonstrated in FIG. 2. This dynamic system has continuously changing magnetic fields which are impacted by magnetic fields produced by current carrying conductors passing through the CT core and by other current carrying conductors in the vicinity of the CT. This dynamic system can be highly susceptible to such fields whose magnitude can vary considerably depending on the orientation of internal conductors within the CT and the proximity of external current carrying conductors. FIG. 6 and Table 3 help to demonstrate this problem.

TABLE 3

| CT Position | 0 | 90 | 180 | 270 |
|---|---|---|---|---|
| mA trip level with no load | 23 | 24 | 22 | 22 |
| current | | | | |
| mA trip level with 63A load | 14 | 18 | 31 | 33 |
| current | | | | |

FIG. 6 shows an active CT with two conductors L, N. Again, the secondary winding has been omitted for convenience. The vertical and horizontal lines represent four different angular positions of 0, 90, 180 and 270 degrees to which the CT core 10 can be rotated about the conductors L, N so as to determine the extent of non-cancellation in each position. This was done to represent four different possible positions of the conductors within the CT core 10 during assembly, but experimentally it was more convenient to rotate the core than to try to reposition the conductors for each position. The system had a nominal IΔn level of 30 mA, i.e. a 30 mA residual current would in theory produce a voltage across C1 in FIG. 2 just sufficient to trip the RCD. Starting at the 0 degree position, a current was passed through conductor L and gradually increased from zero until the RCD tripped. The CT core 10 was successively rotated to the 90 degree position, the 180 degree position and then the 270 degree position, and the trip level was measured in each case. A balanced load current of 63 A was then passed through the conductors and the experiment was repeated. Table 3 shows the minimum and maximum trip levels recorded.

It can be seen that the trip level with no load current was very consistent and comfortably within the specified limits of 0.5-1 IΔn, but when a balanced load current of 63 A was applied, the trip levels changed substantially for each position. In three cases the trip level was outside the accepted limits of 0.5-1 IΔn. This experiment clearly indicates that although the magnetic fields produced by the two conductors are of equal magnitude, they fail to cancel completely, and the extent to which they fail to cancel is highly variable and impacted by the orientation of the two conductors within the CT. This problem can make the production of B Type RCDs uneconomical and manufacturers go to considerable trouble to mitigate this problem. Some manufacturers try to resolve this problem by mechanically positioning and locking the conductors into an optimum position within the CT on an individual product basis. In the above example, the 90 degrees position would appear to be the optimum position. However, such mechanical alignment on an individual basis can be a very slow and costly exercise, and may not result in an acceptable product in all cases. In some cases manufacturers use two CTs for B Type operation, with one CT used to detect AC differential currents and the other used to detect DC differential currents only.

It is an object of the invention to provide a current transformer for use in, e.g. active or passive RCDs, in which the foregoing disadvantages are avoided or mitigated.

### SUMMARY

According to the present invention there is provided a current transformer comprising a plurality of primary conductors passing through a ferromagnetic core and a secondary winding wound on the core, the transformer further including a ferromagnetic member continuously surrounding the primary conductors between the primary conductors and the core.

Preferably the ferromagnetic member comprises a short tube.

In certain embodiment a further ferromagnetic member, preferably also in the form of a short tube, continuously surrounds the core externally.

In such case the first and further ferromagnetic members may be formed as a single component.

Preferably the single component comprises coaxial ferromagnetic tubes joined by an annular member extending generally radially between them.

The current transformer may form part of a passive RCD.

Alternatively, the current transformer may form part of an active RCD.

### BRIEF DESCRIPTION OF THE DRAWINGS FIGURES

Embodiments of the invention will now be described, by way of example, with reference to the accompanying drawings, in which:

FIG. 1 is a circuit diagram of a known type of passive RCD.

FIG. 2 is a circuit diagram of a known type of active RCD.

FIGS. 3, 4, 5A, 5B, and 6 are graphs explaining the problem addressed by the invention.

FIG. 7 shows cross-sectional and side views of an embodiment of current transformer according to the invention.

FIGS. 8 to 10 are graphs illustrating the effects of the embodiment of FIG. 7.

FIGS. 11 and 12 illustrate the effects of an external magnetic field on a CT.

FIG. 13 shows cross-sectional and side views of a second embodiment of current transformer according to the invention which mitigates the effects of the external magnetic field.

FIG. 14 is a graph showing the effect of the second embodiment of the invention.

FIGS. 15a to 15c show practical embodiments of the tubes T1 and T2, individually and combined.

FIG. 16 shows an alternative practical implementation of the current transformer.

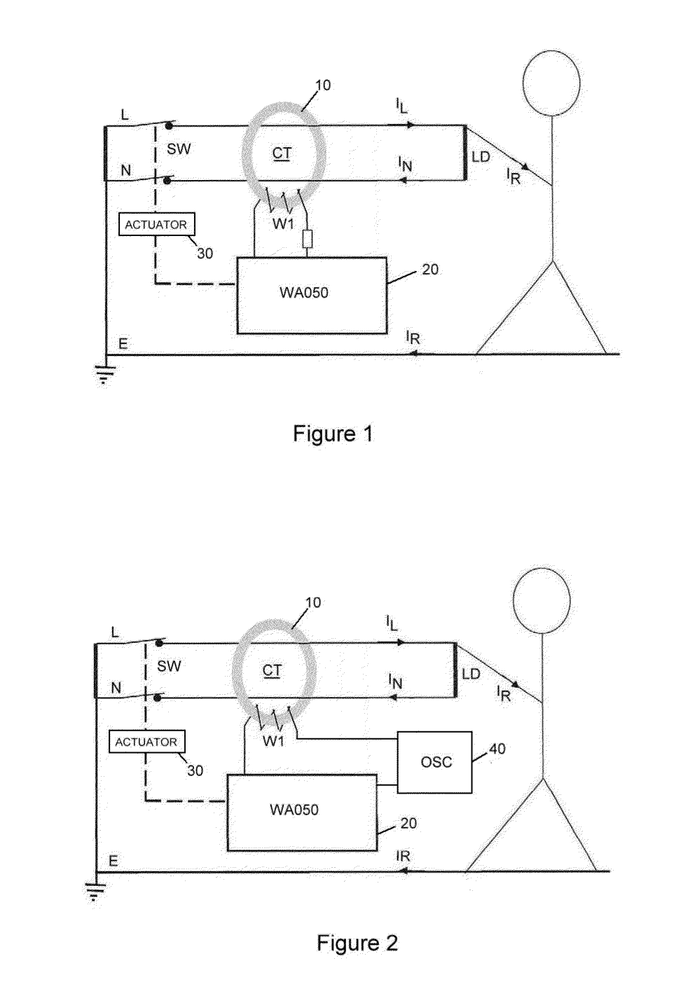

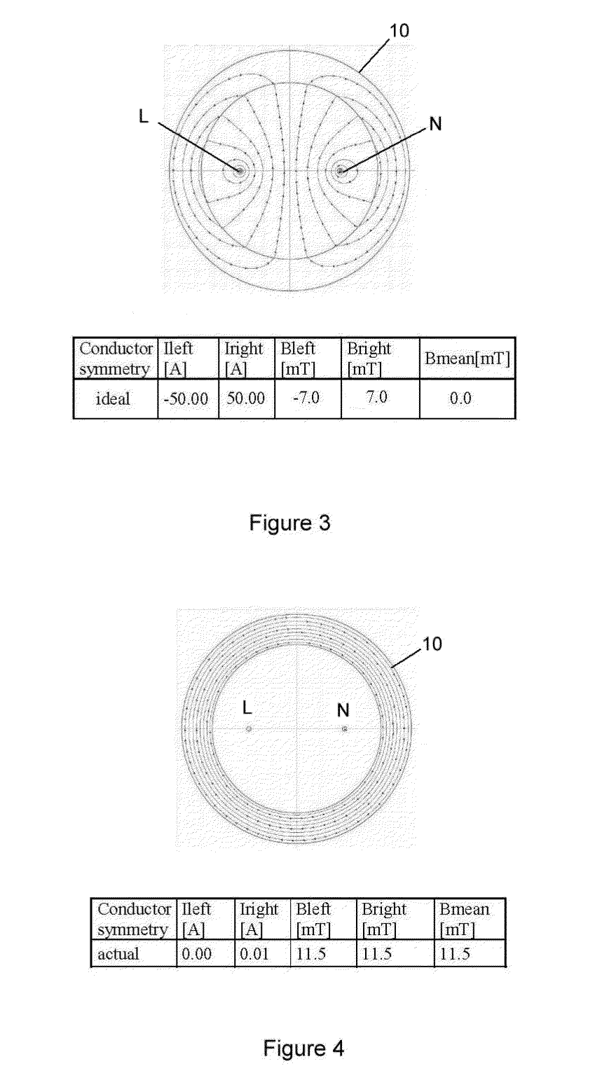

### DETAILED DESCRIPTION

Described herein is a technique which achieves a very high level of cancellation of magnetic fields produced by conductors carrying a balanced load current within active and passive CTs in single and multiphase circuits. There is described an additional technique for mitigating the adverse effects of external magnetic fields on a CT, and means for combining the two techniques within a single component. Such external magnetic fields can be referred to as extraneous fields because of their undesired effects.

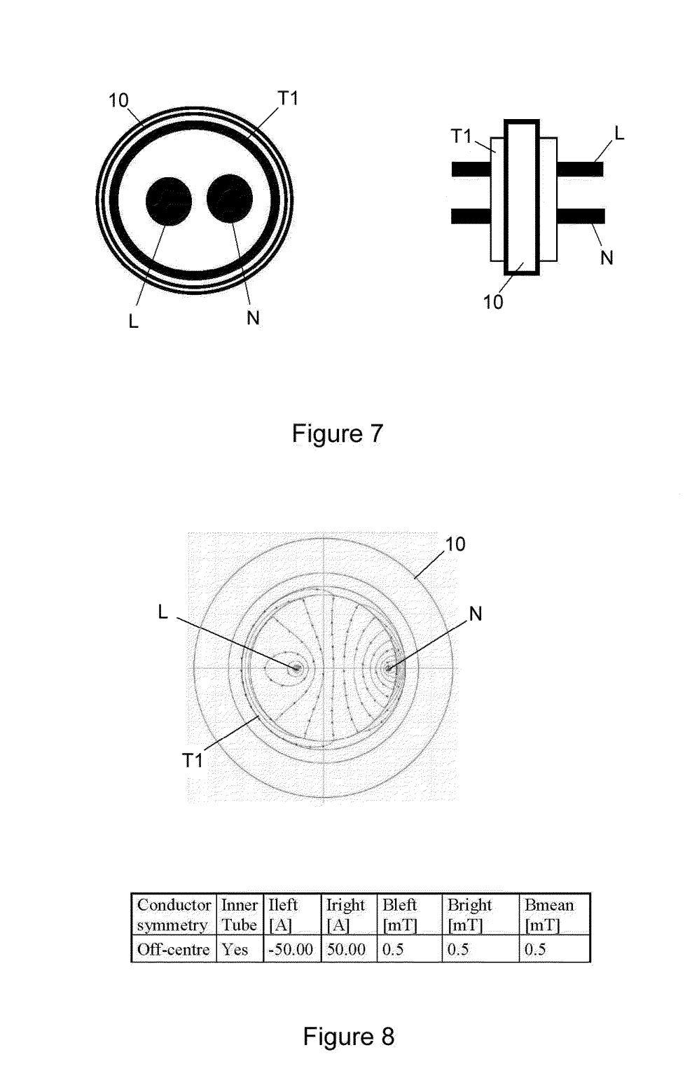

FIG. 7 shows cross-sectional and side views of an embodiment of current transformer according to the invention. In FIG. 7 two primary load conductors L, N pass through the aperture in a toroidal ferromagnetic core 10 of a CT as for a normal RCD. T1 is a is a short cylindrical tube (i.e. its length is less than its diameter) comprising a ferromagnetic material with a relatively high permeability. The tube T1 surrounds the primary conductors L. N and is positioned between the primary conductors and the inner wall of the CT core 10. T1 is made of a ferromagnetic material intended to facilitate cancellation of the magnetic fields produced within the CT core by primary conductors carrying balanced load currents. Each conductor L, N carries the same load current as before, but in this arrangement the fields surrounding each conductor will be induced into the cylindrical tube T1. The material of the tube T1 has a relatively high permeability, for example, greater than that of mild steel, and is dimensioned such that in combination with the material and dimensions of the CT core 10 the magnetic fields produced within the core by primary conductors carrying balanced load currents are cancelled to a substantially greater extent than without the tube T1. The results of this arrangement are shown in FIG. 8.

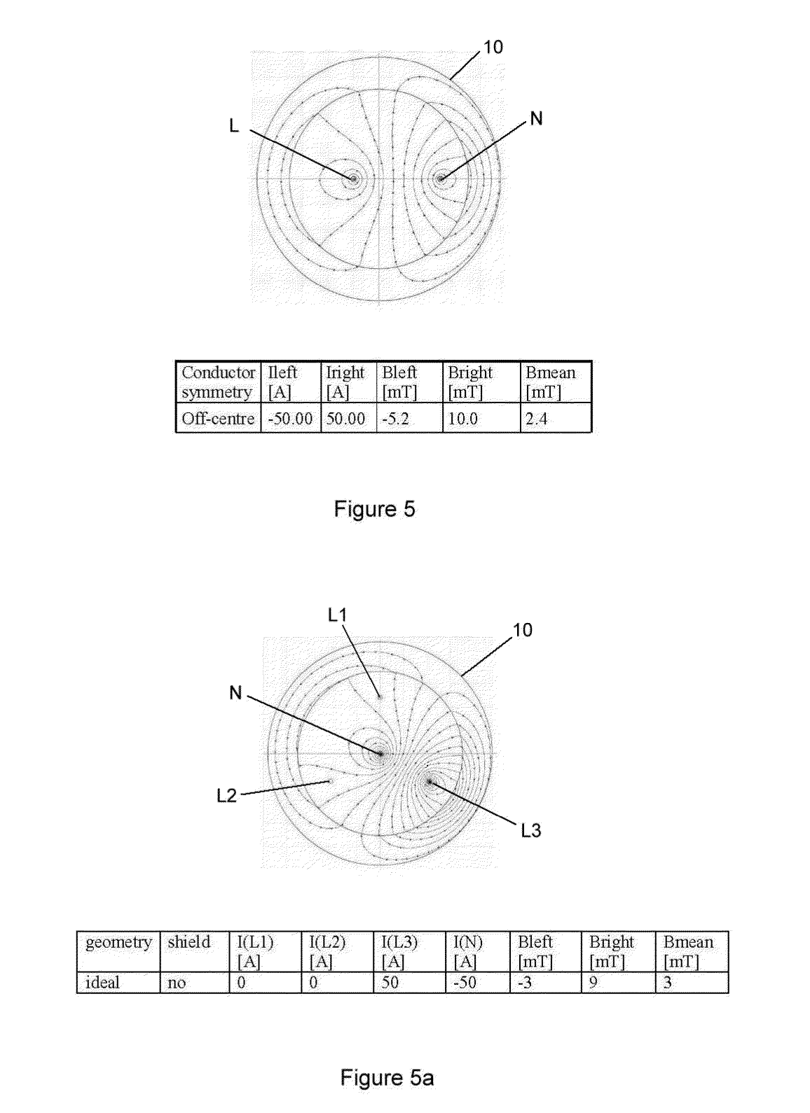

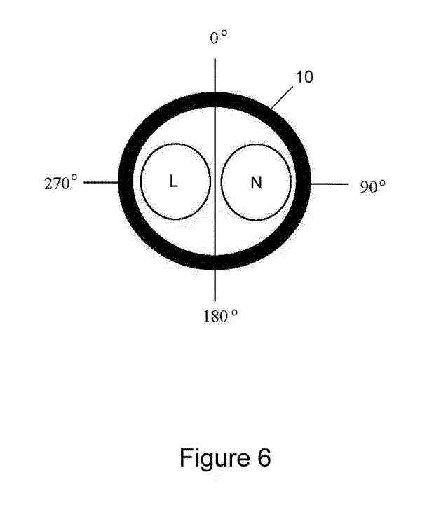

FIG. 8 shows a representation from Vizimag of the effect of placement of the ferromagnetic tube T1 within the CT core 10 with two asymmetrically positioned conductors L, N carrying a balanced load current of 50 A, as shown in FIG. 7. The accompanying data shows that the mean flux induced into the core under this condition is about 0.5 mT although this level of flux cannot be seen in FIG. 8. This is a reduction of about 80% compared to the value produced without the tube as demonstrated by FIG. 5.

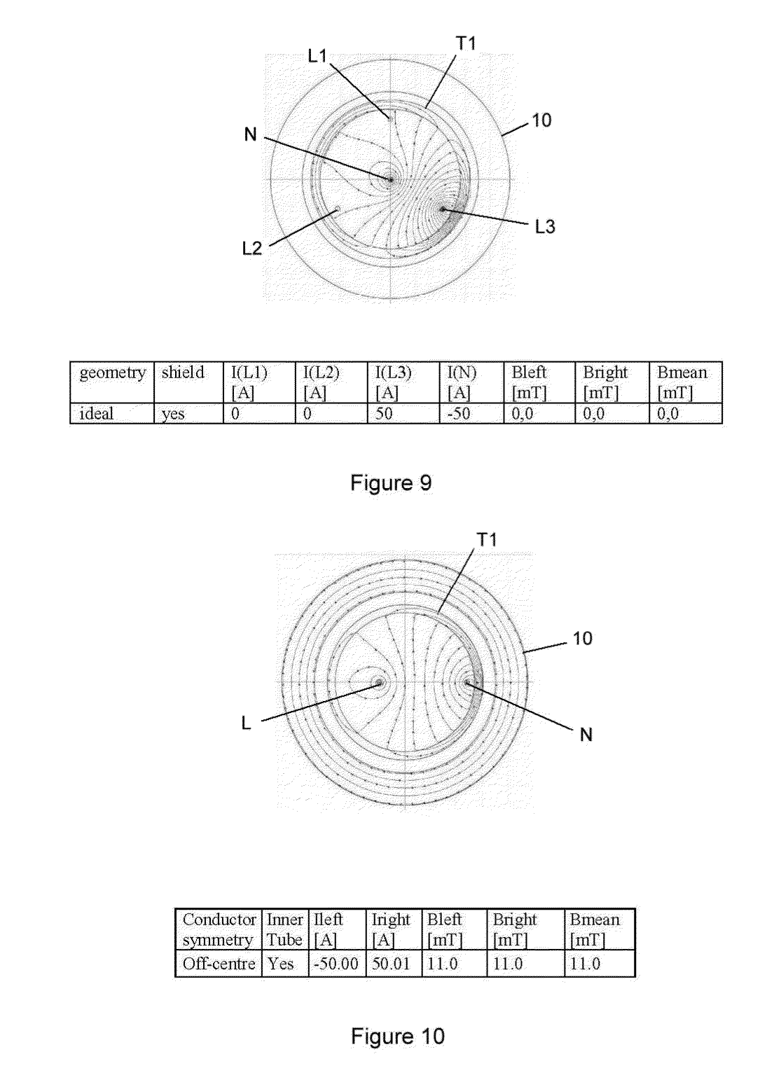

FIG. 9 shows the three phase circuit of FIG. 5 configured for a CT 10 fitted with the tube T1. The results indicate that there is minimal flux induced into the core 10 in contrast to the 3 mT which was induced into the core when not fitted with the tube.

Thus it has been demonstrated that the ferromagnetic tube T1 provides a medium for more effectively cancelling the magnetic fields produced by primary conductors with balanced load currents.

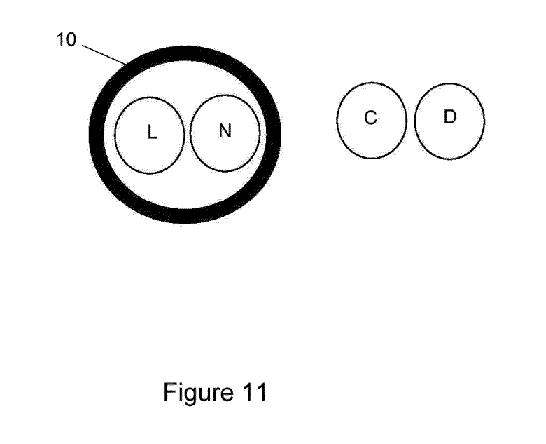

FIG. 10 shows the results obtained when a differential current of 10 mA is applied to the single phase arrangement of FIG. 7.

A mean flux of 11 mT is induced into the CT core 10 even with the presence of the tube T1. In this case, although the fluxes produced by the load currents are cancelled within the tube as before, the differential flux is effectively passed through or via the tube to the CT core because that flux has no equivalent opposing flux with which to be cancelled.

The arrangement of FIG. 7 is highly effective with two, three or four primary conductors because in all cases the individual fluxes are induced into the tube T1 and will cancel under balanced load current conditions, and will produce a net flux and an output from the CT in the event of a differential current.

Current transformers can also be adversely affected by external magnetic fields, as demonstrated by FIG. 11.

In the arrangement of FIG. 11 no load current flows through primary conductors L and N. A current was passed through conductor L only and gradually increased from zero until the RCD tripped. The trip level was recorded as 23 mA.

Conductors C and D were positioned approximately 16 mm away from the CT core 10 and a load current of 63 A was passed through them. A differential current was passed through conductor L and gradually increased from zero until the RCD tripped. The trip level was recorded as 39 mA which was well outside the rated trip level of 30 mA.

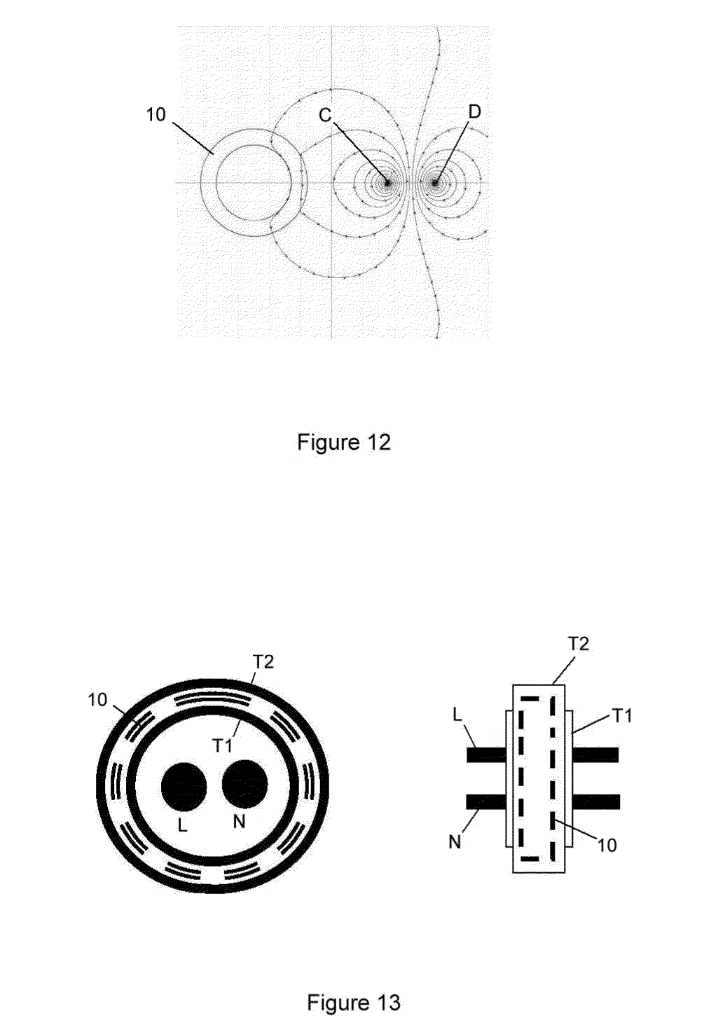

This experiment revealed that the trip level of the RCD could be adversely affected by the magnetic field produced by external current carrying conductors. FIG. 12 shows a Vizimag simulation of this behaviour.

The Vizimag simulation shows two conductors C, D carrying a load current of 125 A in the vicinity of a CT core 10. The simulation clearly shows that the external magnetic field produced by the current carrying conductors can induce a magnetic flux into the CT core. This externally induced flux will impact to some extent on the performance of the CT and may undermine the protection provided by an RCD.

RCDs are generally fitted in switchboards or panels which may include numerous circuit breakers which would produce extraneous magnetic fields which could compromise the performance of the RCD. It is a general requirement of installation rules that equipment and devices installed within a switchboard should be compatible and that performance of a protective device should not be unduly compromised by other devices or conductors. FIG. 12 is a schematic diagram of an arrangement for mitigating the effects of external magnetic fields combined with the solution to achieve cancellation of equivalent fluxes within a CT.

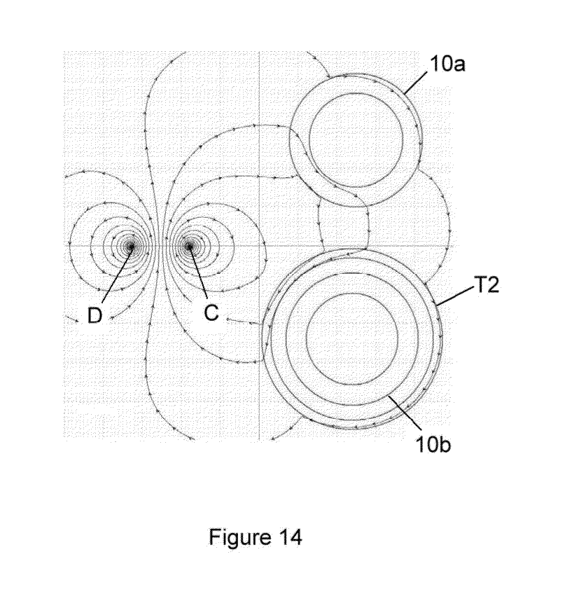

In the arrangement of FIG. 13, an internal tube T1 is fitted as previously described. However, a second tube T2, made of similar material to that of T1, is fitted around the outside of the CT core 10. The effect of fitting this external tube is shown in FIG. 14.

FIG. 14 is a Vizimag simulation which shows two conductors C, D carrying a load current of 125 A in the vicinity of two CT cores 10a and 10b, one with tube T2 fitted and one without. It can be seen that a flux is induced into the core of the CT 10a not fitted with the tube T2, but in the case of the CT 10b fitted with the tube, the external magnetic field is effectively absorbed by the tube. The effect of combining the two solutions in the form of T1 and T2 is demonstrated by Table 11.

TABLE 4

| CT Position | 0 | 90 | 180 | 270 |
|---|---|---|---|---|
| mA trip level with no load | 23 | 24 | 22 | 22 |
| current | | | | |
| mA trip level with 63A load | 24 | 25 | 22 | 21 |
| current and no external | | | | |
| current flow. | | | | |
| mA trip level with 63A load | 26 | 27 | 20 | 18 |
| current and 125A external | | | | |
| current flow. | | | | |

It can be seen that in all four orientations of the conductors, with or without load current and with or without external load carrying conductors, the trip level of the RCD remained within the specified limits of 0.5-1 IΔn under all conditions. This is in sharp contrast to the results shown in Table 6 and indicates the effectiveness of combining these two solutions.

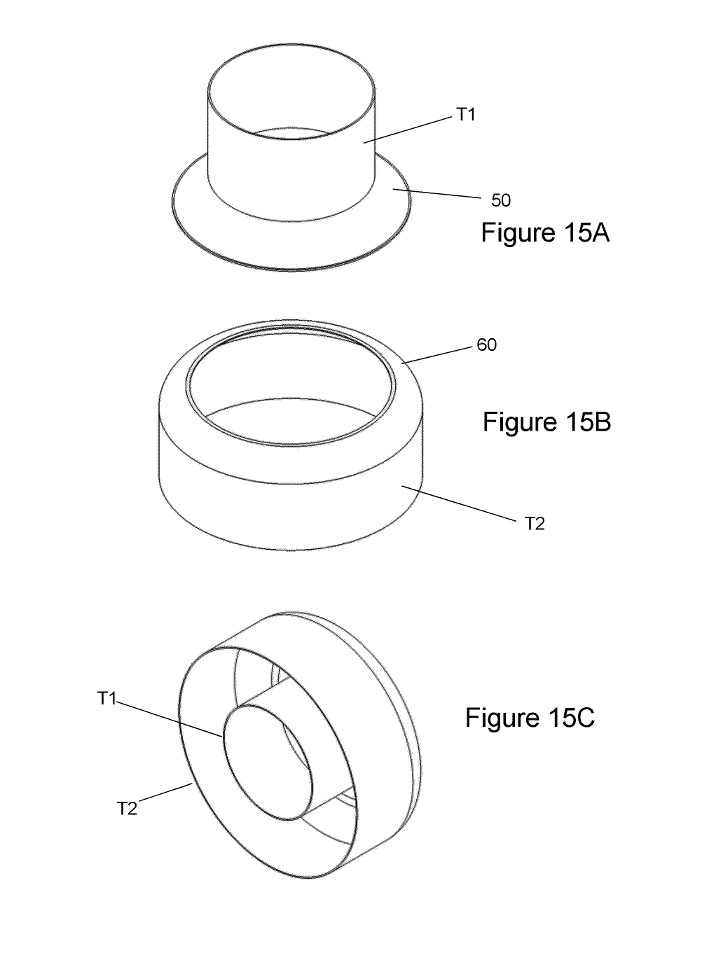

The magnetic fields cancellation solution using the tube T1 may be implemented on its own in cases where external magnetic fields are unlikely to undermine the RCD performance. FIG. 15a shows an embodiment for such an application. It comprises the tube T1 proper and an outwardly extending annular flange 50 at one end by which the tube can be conveniently mounted to the CT.

Likewise, the solution in relation to neutralising the effects of external magnetic fields using the tube T2 may be used on its own where core balance problems are unlikely to undermine RCD performance. FIG. 15b shows an embodiment for this application. It comprises the tube T2 proper and an inwardly extending annular flange 60 at one end by which the tube can be conveniently mounted to the CT.

Both solutions may be used together to mitigate both problems, and if so the two tubes T1 and T2 may advantageously be combined in a single component in the form of a double walled tube. FIG. 15c shows an embodiment for this arrangement where the tubes T1 and T2 are joined together coaxially by an annular member 70 extending generally radially between them which is effectively the outer periphery of the flange 50 joined to the inner periphery of the flange 60.

The double walled tube arrangement shown in FIG. 15c is designed to fit on the CT core 10 like a cap, and may be made by extrusion or be deep drawn as appropriate.

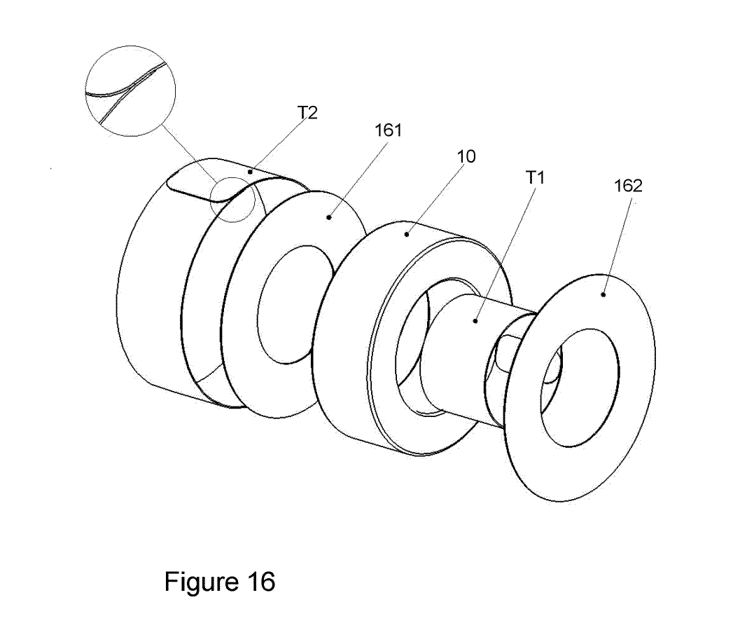

FIG. 16 shows an alternative arrangement to that of FIG. 15. This comprises the two tubes T1 and T2 as before, but with a cap 161, 162 placed on either side of the CT 10, each cap acting to completely encase the tubes and the CT within a magnetic cage. The tubes and caps are all made of similar ferromagnetic material.

Thus, inner tube T1 is placed inside the CT, and outer tube T2 is placed over the CT. An end cap 161,162 placed on each end of the CT and tube assembly.

The tubes T1 and T2 can be formed by extrusion, or by pressing out flat rectangular pieces which are then formed into a tubular shape with an area of overlap that can be spot welded to hold the tubular shape, as illustrated in detail in FIG. 16. The end caps 161, 162 can be pressed in the form of washers. From a manufacturing perspective, this provides a more cost effective implementation than that of FIG. 15.

In the above embodiments the CT core 10 is shown as a circular toroid. However, it can be any shape (e.g. circular, rectangular) provided the secondary W1 is wound on it substantially symmetrically relative to the primary conductors which should themselves be positioned at least nominally symmetrically within the core.

Thus there has been described herein a simple but highly effective technique which mitigates the adverse effects of extraneous magnetic fields produced by conductors within a current transformer or external to the current transformer. The CTs may be active or passive types. The solutions may be used individually or together. The tubes may be individual components or a single combined component.

The present disclosure is not limited to the embodiments described herein which may be modified or varied without departing from the scope of the disclosure.

1. A current transformer comprising a plurality of primary conductors passing through a ferromagnetic core and a secondary winding wound on the core, the transformer further including a ferromagnetic member continuously surrounding the primary conductors between the primary conductors and the core.

2. A current transformer as claimed in claim 1, wherein the ferromagnetic member comprises a short tube.

3. A current transformer as claimed in claim 2 wherein a further ferromagnetic member continuously surrounds the core externally.

4. A current transformer as claimed in claim 3 wherein said further ferromagnetic member is also in the form of a short tube.

5. A current transformer as claimed in claim 4 wherein the first and further ferromagnetic members are formed from respective flat pieces, each formed into a tubular shape with their otherwise free ends fixed together.

6. A current transformer as claimed in claim 5 wherein said first and further ferromagnetic members are maintained in place between a pair of annular end pieces.

7. A current transformer as claimed in claim 4 wherein the first and further ferromagnetic members are formed as a single component.

8. A current transformer as claimed in claim 7 wherein the single component comprises coaxial ferromagnetic tubes joined by an annular member extending generally radially between them.

9. A passive RCD including the current transformer of claim 1.

10. An active RCD including the current transformer of claim 1.
